(19) United States
(12) Patent Application Publication
(10) Pub. No.: US 2005/0095829 A1
(43) Pub. Date: May 5, 2005

(54) Housing unit and exposure method using the same

(76) Inventor: Shinichi Hara, Kanagawa (JP)

Correspondence Address: MORGAN & FINNEGAN, L.L.P., 3 WORLD FINANCIAL CENTER, NEW YORK, NY, 10281-2101, US

(21) Appl. No.: 10/965,498

(22) Filed: Oct. 14, 2004

(30) Foreign Application Priority Data
Oct. 15, 2003 (JP) 2003-354682

(51) Int. Cl. G03B 27/62

(52) U.S. Cl. 438/584

(57) ABSTRACT

A housing unit used to feed an object from a first atmosphere to a second atmosphere different from the first atmosphere includes a support member for supporting the object via a contact surface that contacts the object, and an antislip device that prevents slippery of the object relative to the support member.

### BACKGROUND OF THE INVENTION

The present invention relates generally to a housing unit, and more particularly to a housing unit that houses a plate, such as a reticle, used for an exposure apparatus that manufactures devices, such as a single crystal substrate for a semiconductor wafer, and a glass substrate for a liquid crystal display (“LCD”). The present invention is suitable, for example, for an exposure apparatus that utilizes an electron beam (“EB”), X-ray, and extreme ultraviolet (“EUV”) light for an exposure light source.

A reduction projection exposure apparatus has been conventionally employed which uses a projection optical system to project a circuit pattern formed on a mask (reticle) onto a wafer, etc. to transfer the circuit pattern, in manufacturing such a fine semiconductor device as a semiconductor memory and a logic circuit in photolithography technology.

The minimum critical dimension to be transferred by the projection exposure apparatus or resolution is proportionate to a wavelength of light used for exposure, and inversely proportionate to the numerical aperture (“NA”) of the projection optical system. The shorter the wavelength is, the better the resolution is. The recent demands for fine processing of a semiconductor device promote the shortened wavelength of the exposure light. Exposure light sources have currently been in transition from KrF excimer laser (with a wavelength of approximately 248 nm) and ArF excimer laser (with a wavelength of approximately 193 nm) to F₂ excimer laser (with a wavelength of approximately 157 nm). The EUV light is about to reduce to practice.

Since the exposure light with a short wavelength dramatically attenuates in the air, an exposure apparatus is housed in an exposure chamber that is maintained under the reduced pressure or in vacuum atmosphere for reduced attenuations. Such an exposure apparatus includes a mini-environment and load lock chamber so as to convey a reticle and wafer between the exposure chamber and a plate feed section (“pod”) located in the air. In other words, the reticle and wafer are fed from the pod located in the air to the exposure chamber via the mini-environment and the load lock chamber.

Those exposure apparatuses that use a KrF or ArF excimer laser as an exposure light source provide a reticle with a thin film (or pellicle film) that transmits the exposure light and has, for example, several micromillimeters, in order to prevent adhesions of particles or dust onto its pattern surface, on which a circuit pattern is formed, and to protect the pattern surface during feeding of the reticle.

On the other hand, an exposure apparatus that uses the EUV light as a light source, which is referred to as an “EUV exposure apparatus” hereinafter, cannot utilize the pellicle film because its material greatly absorbs the exposure light (or the EUV light). For example, even an extremely thin pellicle film having a coating thickness of 0.5 μm, made of silicon (Si) has a relatively high transmittance of about 43% to the EUV light. Since the EUV exposure apparatus utilizes a reflection reticle, the EUV light passes through the pellicle film twice and the transmittance reduces down to about 18%.

When the reticle that has no pellicle film is being fed, particles adhere to its pattern surface during the feeding of the reticle, for example, during drawing a vacuum (or exhaustion) of a load lock chamber, preventing the exposure light from reflecting and transmitting, and disadvantageously causing exposure defects and lowered yield.

Accordingly, Japanese Patent No. 3,320,628, which corresponds to U.S. Pat. No. 6,090,176, proposes to house a reticle in a cassette when the reticle that has no pellicle film is being fed, and to take the reticle out of the cassette after the cassette is fed to the exposure chamber.

A support member that supports a reticle in a conventional cassette generally uses hard and lightweight plastic so as to protect the inside of the cassette. Thus, the support member is likely to damage the reticle when the reticle slips relative to the support member when the cassette is being fed, and surfaces of the support member and/or the reticle are peeled off, causing particles. The plastic support member is so hard to the reticle that the stress concentration generates particles similarly.

The support member generally supports the reticle whose pattern surface faces down, and thus is located close to a circuit pattern. Due to the contact between the support member and the reticle, the generated particles can adhere the circuit pattern. In other words, the conventional cassette can protect the reticle from particles outside the cassette, but generate particles inside the cassette and cannot prevent the particles generated inside the cassette from adhering to the reticle.

It is demanded to provide a housing unit and an exposure method using the same, which reduce generations of inside particles and prevent the particles from adhering to an object to be fed.

### BRIEF SUMMARY OF THE INVENTION

A housing unit according to one aspect of the present invention used to feed an object from a first atmosphere to a second atmosphere different from the first atmosphere includes a support member for supporting the object via a contact surface that contacts the object, and an antislip device that prevents slippery of the object relative to the support member.

The housing unit may further include a body, and a lid that can be detached from the body, wherein each of the body and lid is provided with the support member so as to hold the object to be fed. The antislip device may be an elastic member provided at least on the contact surface. The elastic member may have a Young's modulus of 1×10⁻² Pa or smaller. The antislip device may be provided on the contact surface, and include a chuck for clamping the object. The chuck may be an electrostatic clamping plate that generates an electrostatic absorptive force. The electrostatic absorptive force may be 50 N or greater. The housing unit may further include a differential pressure remover for removing a pressure difference between the inside and the outside of the housing unit.

A housing unit according to another aspect of the present invention used to feed an object from a first atmosphere to a second atmosphere different from the first atmosphere includes a support member for supporting the object and follows slips of the object.

The object to be fed may be a reticle that has a pattern surface, on which a predetermined pattern is formed, or a wafer, onto which a predetermined pattern is formed. The housing unit may further include an airtight member that airtightly seals the first atmosphere from the second atmosphere.

An exposure method according to another aspect of the present invention that uses an exposure apparatus that includes an exposure chamber maintained under a reduced pressure or in a vacuum atmosphere, to expose a pattern on a reticle onto a wafer includes the steps of accommodating the reticle or wafer in the above housing unit, exhausting the inside of the housing unit that accommodates the reticle or wafer by the accommodating step, down to the reduced pressure or vacuum atmosphere, feeding the housing unit to the exposure chamber inside of which has the reduced pressure or vacuum atmosphere, and setting in the exposure apparatus the reticle or wafer accommodated in the housing unit fed by the feeding step.

A device fabricating method includes the steps of exposing a pattern on the reticle onto the wafer by using the above exposure method, and developing the wafer exposed.

Other objects and further features of the present invention will become readily apparent from the following description of the preferred embodiments with reference to accompanying drawings.

### BRIEF DESCRIPTION OF THE DRAWINGS

FIG. 1 is a schematic sectional view of a structure of a housing unit according to one aspect of the present invention.

FIG. 2 is a schematic top view showing an arrangement of a first support member shown in FIG. 1.

FIG. 3 is a schematic sectional view showing a state that the support member follows slips of the reticle.

FIG. 4 is a schematic sectional view of another structure of a differential pressure remover shown in FIG. 1.

FIG. 5 is a schematic sectional view of another structure of a differential pressure remover shown in FIG. 1.

FIG. 6 is a schematic sectional view of another structure of a differential pressure remover shown in FIG. 4.

FIG. 7 is a schematic sectional view of a structure of a housing unit as a variation of the housing unit shown in FIG. 1.

FIG. 8 is a schematic top view showing an arrangement of a chuck shown in FIG. 7.

FIG. 9 is a schematic sectional view for explaining an exposure method according to one aspect of the present invention.

FIG. 10 is a schematic sectional view for explaining a method for collecting a reticle loaded onto a reticle stage in an exposure apparatus.

FIG. 11 is a flowchart for explaining a method for fabricating devices (semiconductor chips such as ICs, LSIs, and the like, LCDs, CCDs, etc.).

FIG. 12 is a detailed flowchart for Step 4 of wafer process shown in FIG. 11.

### DETAILED DESCRIPTION OF THE PREFERRED EMBODIMENTS

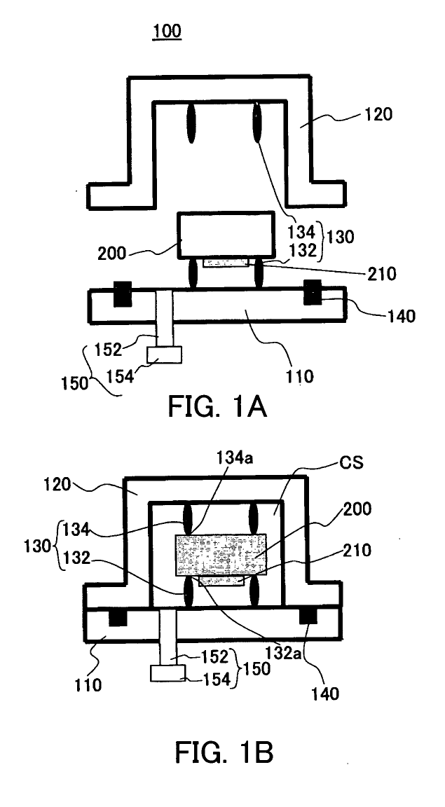

A description will now be given of a housing unit according to one aspect of the present invention with reference to the accompanying drawings. Like elements in each figure are designated by the same reference numerals, and a duplicate description will be omitted. Here, FIGS. 1A and 1B are schematic sectional views of a structure of the housing unit 100 according to one aspect of the present invention, wherein FIG. 1A shows a state prior to the accommodation of a reticle 200, and FIG. 1B shows a state subsequent to the accommodation of the reticle 200.

The inventive housing unit 100 is used to feed an object from a first atmosphere to a second atmosphere different from the first atmosphere, and particularly suitable for accommodations of a reticle and wafer in feeding them to an EUV exposure apparatus that includes an exposure chamber maintained in a vacuum atmosphere. In a description of the instant embodiment, the housing unit 100 houses the reticle 200 as an object to be fed.

The housing unit 100 includes, as shown in FIG. 1, a body 110, a lid 120, a support member 130, an airtight member 140, and a differential pressure removal 150.

The body 110 forms an accommodation space CS in cooperation with the lid 120 that can be detached from the body 110. The accommodation space CS accommodates the reticle 200, and seals it from the external atmosphere, preventing particles outside the housing unit 100 from adhering to the reticle 200. While the instant embodiment enables the lid 120 to be detachable so as to form an opening through which the reticle 200 is inserted into the accommodation space CS, the body 110 and lid 120 can be integrated into one member having a window that can open and close and serve as an opening to accommodate the reticle 200. While the instant embodiment forms the body 110 as a plate member and the lid 120 as a convex section, their shapes are not limited as long as they can form the accommodation space CS for accommodating the reticle 200 when they are connected to each other.

The support member 130 includes a first support member 132 provided onto the body 110, and a second support member 134 provided onto the lid 120, and supports the reticle 200 via contact surfaces 132a and 134a that contact the reticle 200.

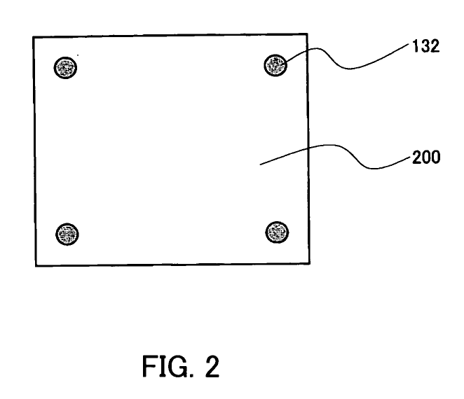

Four first support members 132 are arranged, as shown in FIG. 2, on the body 110 and support four corners of the rectangular reticle 200 (i.e., four point mounting). The first support members 132 support the reticle 200 at the side of the pattern surface 210, on which a circuit pattern is formed. In other words, the first support members 132 are adapted to support the reticle 200 so that the pattern surface 210 of the reticle 200 faces down in the gravity direction, preventing the particles that drop due to the gravity from adhering to the pattern surface 210. Here, FIG. 2 is a schematic top view of the first support members 132 shown in FIG. 1.

The second support members 134 are arranged on the lid 120 opposite to the first support members 132 with respect to the reticle 200. In other words, as shown in FIG. 1B, the reticle 200 is held and fixed by the first and second support members 132 and 134.

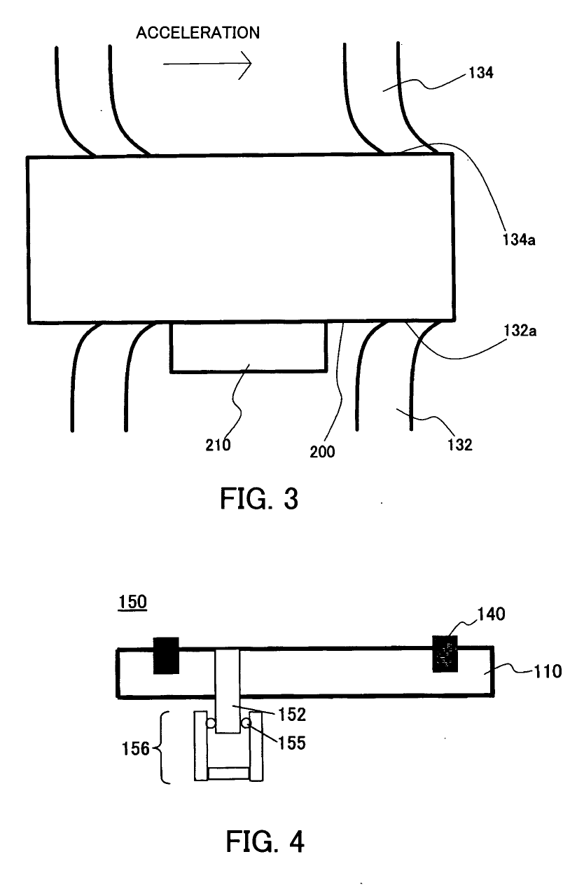

The support member 130 is an elastic member, such as fluororubber, which has a Young's modulus of 1×10⁻² Pa or smaller, and serves as an antislip device that prevents slippery of the reticle 200 relative to the support member 130. More specifically, even when the acceleration applies to the reticle when the reticle 200 is being fed, deformations of the support member 130 as an elastic member (more specifically, deformations of the contact surfaces 132a and 134a) mitigate, as shown in FIG. 3, the slippery force between the reticle 200 and the support member 130. In other words, the support member 130 (or the contact surfaces 132a and 134a) can serve as an elastic member, and follow the slides of the reticle 200 and substantially cancel the slides of the reticle 200. This configuration prevents the reticle 200 from slips relative to the support member 130, and reduces the particles generated in the accommodation space CS. When the Young's modulus of the elastic member of the support member 130 is greater than 1×10⁻² Pa, the support member 130 becomes hard to deform relative to slips of the reticle 200, and undesirably causes particles. The fluororubber support member 130 emits a reduced amount of polymer organic gas or is less likely to generate contaminations. Here, FIG. 3 is a schematic sectional view showing a state where the support member 130 follows the slides of the reticle 200.

Since the support member 130 is an elastic member, the contact surfaces 132a and 134a deform to enlarge the contact areas, lowering the contact pressure. This configuration can reduce generations of particles that result from peeling off of part of the contact surfaces 132a and 134a of the reticle 200 or the support member 130, when the reticle 200 is supported or at the time of contact between the reticle 200 and the support member 130.

The present invention is not limited to the instant embodiment that makes the entire support member 130 of an elastic member, as long as at least the contact surfaces 132a and 134a serve as an elastic member. When the entire support member 130 is made of an elastic member, the particles due to the elastic deformations reduce at connection parts of the body 110 and lid 120, similar to the reticle 200 and the support member 130. A force of about 50 N is needed between the reticle 200 and the support part 130 due to (the weight of the reticle 200)×(the maximum feeding speed of the reticle 200)×(safety coefficient)×(frictional coefficient).

The airtight member 140 is made, for example, of fluororubber, and provided on the body 110 in the instant embodiment. The airtight member 140 serves to airtightly seal the accommodation space CS from the outside. When the support member 130 supports the reticle 200, the airtight member 140 adheres the body 110 to the lid 120, making the accommodation space CS airtight. This configuration can prevent the particles from entering the accommodation space CS. Similar to the support member 130, the airtight member 140 made of fluororubber can reduce contaminations.

The differential pressure remover 150 includes, for example, a tubular air supply and exhaust opening 152 and a valve 154, and removes a pressure difference between the accommodation space CS (or the inside of the housing unit 100) and the outside. More specifically, for example, in drawing a vacuum in the load lock chamber to which the housing unit 100 is fed, the valve 154 is opened so that no pressure difference occurs between the accommodation space CS and the outside via the air supply and exhaust opening 152. In other words, the drawing a vacuum in the load lock chamber also draws a vacuum in the accommodation space CS, and the force necessary to detach the lid 120 from the body 110 to take the reticle 200 out of the housing unit 100 is maintained irrespective of the pressure difference.

In order to feed the housing unit 100 to the air ambient, the valve 154 is opened with the air supply to the load lock chamber so as to supply to the accommodation space CS the air from which particles are eliminated, via the air supply and exhaust opening 152. As a result, the pressure difference between the accommodation space CS and the outside is removed and the air, and particles are prevented from entering the accommodation space CS. Thereby, an intentional supply of air from an external, high-pressure supply source quickly eliminates the pressure loss and the pressure difference, improving the throughput.

The differential pressure remover 150 may, for example, be a removable plug 156 that is engageable with the tubular air supply and exhaust opening 152 via a seal member 155 as shown in FIG. 4, instead of the valve 154, in drawing a vacuum in the load lock chamber. Here, FIG. 4 is a schematic sectional view showing another structure of the differential pressure remover 150 shown in FIG. 1.

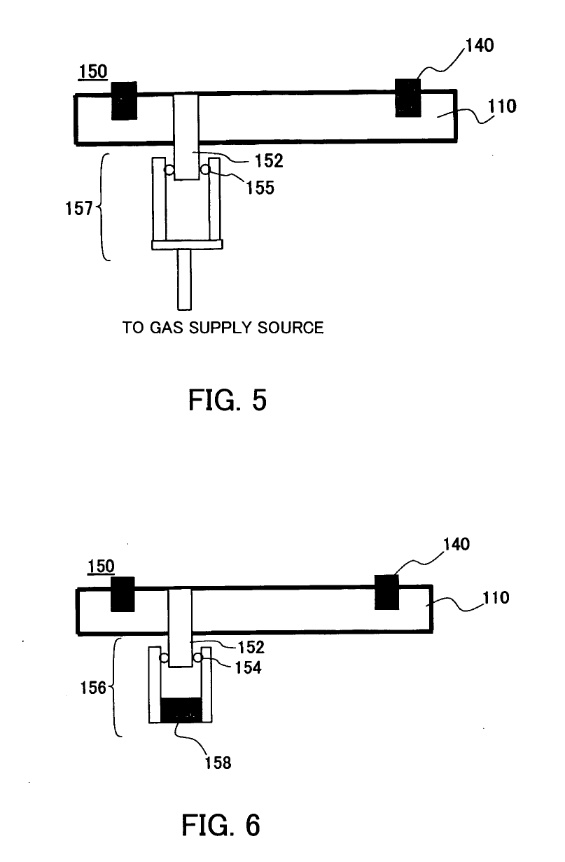

The differential pressure remover 150 can use, for example, an air introduction attachment 157 that is engaged with the tubular air supply and exhaust opening 152 via the seal member 155 as shown in FIG. 5 in drawing a vacuum in the load lock chamber. The air introduction attachment 157 can reduce particles that flow in the accommodation space CS via the air supply and exhaust opening 152 when the valve 154 opens and closes. A structure that provides the plug 156 shown in FIG. 4 with a filter 158 as shown in FIG. 6, can easily prevent intrusions of particles, and remove the differential pressure. Here, FIG. 5 is a schematic sectional view showing another structure of the differential pressure remover 150 shown in FIG. 1. FIG. 6 is a schematic sectional view showing another structure of the differential pressure remover 150 shown in FIG. 4.

In operation of the housing unit 100, the first support members 132 provided on the body 110 support the reticle 200 via the contact surface 132a, and the lid 120 is attached to the body 110. When the lid 120 is attached, the second support members 134 provided on the lid 120 hold the reticle 200, and the reticle 200 is fixed in the accommodation space CS formed by the body 110 and lid 120. This structure seals the accommodation space CS from the outside, and prevents particles from entering the accommodation space CS. The first and second support members 132 and 134 made of elastic members can reduce generations of particles when contacting the reticle 200. In other words, the housing unit 100 reduces generations of particles in the accommodation space CS for accommodating the reticle 200. Thereby, the accommodation unit 100 prevents adhesions of particles onto the reticle 200, and maintains the high-quality process without lowering the yield.

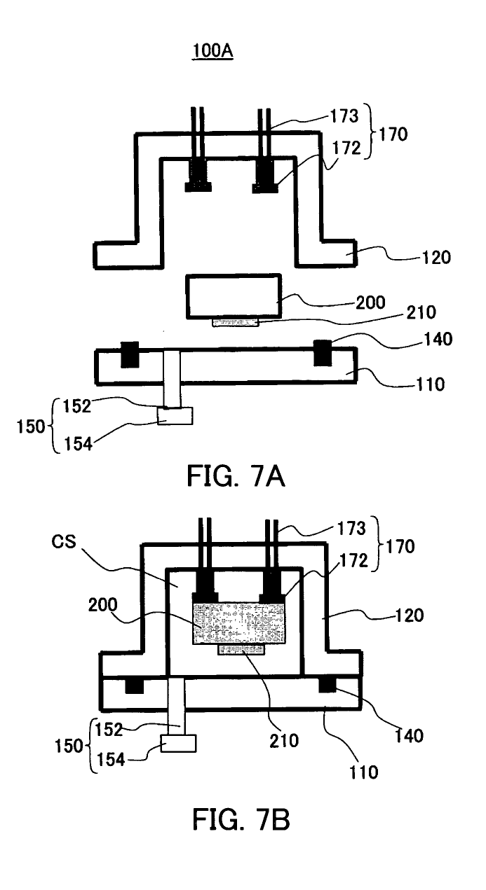

A description will now be given of a housing unit 100A as a variation of the housing unit 100 shown in FIG. 1, with reference to FIGS. 7A and 7B. FIG. 7A are schematic sectional views showing a structure of the housing unit 100A as a variation of the housing unit 100 shown in FIG. 1, wherein FIG. 7A shows a state prior to an accommodation of the reticle 200, and FIG. 7B shows a state subsequent to an accommodation of the reticle 200. The housing unit 100A is similar to the housing unit 100, but different in structure of the support member 170.

The support member 170 is provided on the lid 120 in the instant embodiment, and includes a chuck 172 for clamping the reticle 200 on the contact surface that contacts the reticle 200. The chuck 172 is implemented as a polyimide electrostatic chuck to which an electrode 173 is connected to supply the voltage to this electrostatic chuck. The chuck 172 generates the electrostatic absorptive force by applying the voltage to the electrode 173, and this electrostatic absorptive force absorbs the reticle 200. The electrostatic absorptive force of about 50 N is needed to absorb the reticle 200 due to (the weight of the reticle 200)×(the maximum feeding speed of the reticle 200)×(safety coefficient)×(frictional coefficient). After the chuck 172 absorbs the reticle 200, the lid 120 is attached to the body 110 in the housing unit 100A so as to form the airtight accommodation space CS that accommodates the reticle 200, and prevent particles from entering from the outside.

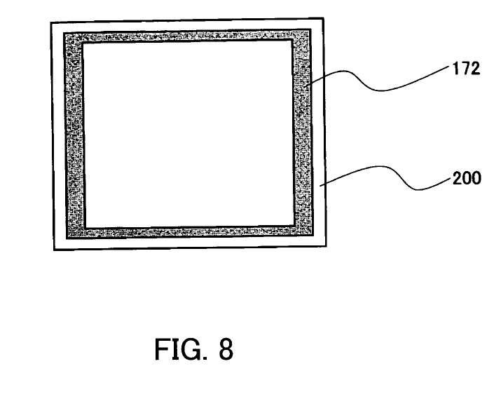

The chuck 172 has a rectangular shape and is arranged on the lid 120, as shown in FIG. 8, so as to absorb the periphery of the rectangular reticle 200. The chuck 172 made of one member is advantageous because only one voltage supply system is sufficient to supply the voltage to the electrode 173. The chuck 172 is arranged on the lid 120, in order to absorb the reticle 200 while the pattern surface 210 of the reticle 200 faces down in the gravity direction. This is preferable because particles in the vacuum drop due to the gravity. Unlike the support by the gravity like the support member 130, the chuck 172 contacts the non-pattern surface (or a surface opposite to the pattern surface 210) of the reticle 200 and supports the reticle 200 as shown in FIG. 7B. Therefore, the contact portion and the pattern surface 210 can be spaced, making particles less likely to adhere the pattern surface 210. Here, FIG. 8 is a schematic top view showing an arrangement of the chuck 172 shown in FIG. 7.

The electrostatic absorptive force generated by the chuck 172 on the surface enlarges the contact area with the reticle 200, and lowers the contact pressure. This configuration can reduce generations of particles that result from peeling off of part of the reticle 200 or the chuck 172, when the reticle 200 is supported (or when the chuck 172 absorbs the reticle 200).

The chuck 172 can absorb the reticle 200 by the residual electrostatic absorptive force even when the electric power supply temporarily stops. Therefore, it is unnecessary to always connect the electrode 173 to the voltage supply system (not shown) via a cable (not shown), for example, in feeding the housing unit 100A to the exposure chamber. Therefore, the cable does not obstruct or prevent feeding of the housing unit 100A. The chuck 172 is supplied with the voltage only at the beginning of feeding (or when the reticle 200 is absorbed) when the feeding time is short or there are enough residual charges. This is advantageous because no voltage supply system needs to be installed in the middle of the feeding path, for example, in the load lock chamber or the like.

The dielectric material of the chuck 172 is polyimide that generates few particles, and can restrain generations of the particles. The polyimide chuck 172 has more residual charges than other materials, and provides the above effect that no voltage supply system needs to be installed in the load lock chamber or the like.

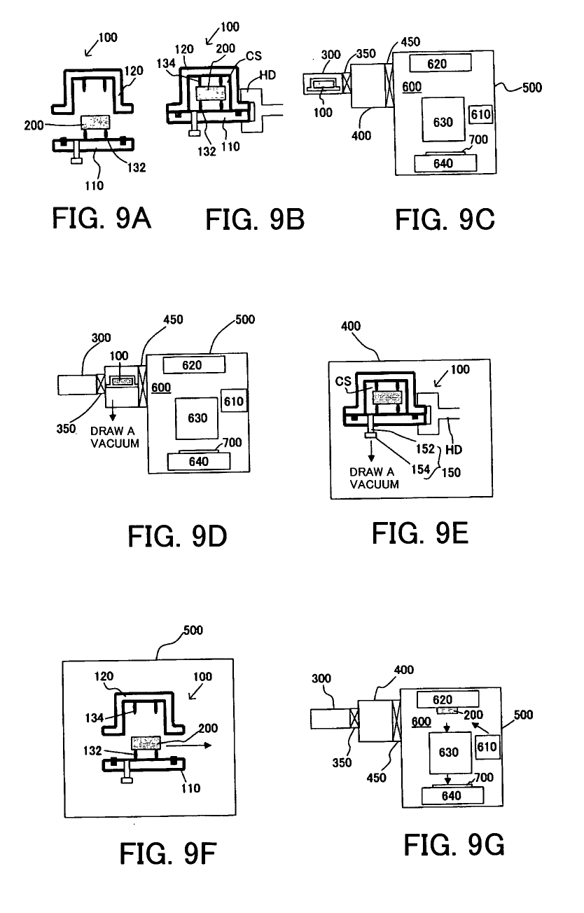

A description will be given of an exposure method using the housing unit 100 or 100A, with reference to FIG. 9. While the instant embodiment discusses the exposure method using the housing unit 100, the exposure method using the housing unit 100A is similar. Here, FIG. 9 is a schematic sectional view for explaining an exposure method 1000 according to one aspect of the present invention. The exposure method 1000 is an exposure method that exposes a pattern on the reticle 200 using an exposure apparatus 600 that includes an exposure chamber 500 that is maintained under the reduced pressure or in the vacuum atmosphere.

First, as shown in FIG. 9A, the reticle 200 is mounted on the first support members 132 provided on the body 110 under the clean environment (not shown). Then, as shown in FIG. 9B, the lid 120 is attached to the body 110 onto which the reticle 200 is mounted, so as to accommodate the reticle 200 in the accommodation space CS. In this case, the housing unit 100 adheres the body 110 to the lid 120 by the hand HD.

The housing unit 100 that houses the reticle 200 is installed, as shown in FIG. 9C, in a pod 300 under the clean environment (not shown). SMIF, FOUP, etc. are known as the pod 300. A valve 350 is opened between the pod 300 and a load lock chamber 400. For simple explanation, the instant embodiment omits the mini-environment, which is a space that is provided between the pod 300 and the load lock chamber 400, and maintained to have cleanness of class 1 or less, for example, by circulating clean air.

When the valve 350 is opened, as shown in FIG. 9D, the housing unit 100 is fed from the pod 300 to the load lock chamber 400, and then the valve 350 is closed between the pod 300 to the load lock chamber 400. The valve 154 provided at the air supply and exhaust opening 152 is opened in the housing unit 100, and a vacuum pump (not shown) draws a vacuum in the load lock chamber 400 down to the degree of vacuum of about 1×10⁻⁴ Pa. In this case, since the valve 154 provided at the air supply and exhaust opening 152 is opened, the accommodation space CS is also exhausted, as shown in FIG. 9E. The vacuum pump may be connected to the air supply and exhaust opening 152, and draws a vacuum in addition to load lock chamber 400.

When the degree of vacuum of the load lock chamber 400 becomes about 1×10⁻⁴ Pa, the drawing a vacuum stops and the valve 154 of the air supply and exhaust opening 152 is closed. Next, the valve 450 is opened between the load lock chamber 400 and the exposure chamber 500, and the housing unit 100 is fed from the load lock chamber 400 to the exposure chamber 500.

When the housing unit 100 is fed to the exposure chamber 500, the valve 450 is closed between the load lock chamber 400 and the exposure chamber 500. Next, as shown in FIG. 9F, the lid 120 is detached from the body 110, and the reticle 200 is taken out of the housing unit 100. The reticle 200 is loaded onto the reticle stage 620 in the exposure apparatus 600 in the exposure chamber 500, as shown in FIG. 9G.

When the reticle 200 is loaded onto the reticle stage 620, the EUV light emitted from the EUV light source (not shown) is directed to the reticle 200 on the reticle stage 620 via an EUV illumination optical system 610. The EUV light that is reflected on the reticle 200 and possesses the reticle pattern information is imaged on a wafer 700 mounted on a wafer stage 640 via a projection optical system that includes plural mirrors. The entire reticle pattern is transferred by scanning the reticle 200 via the reticle stage 620 and the wafer 700 via the wafer stage 640.

The exposure method 1000 carries the reticle 200 while storing it in the clean accommodation space CS in the housing unit 100, reduces adhesions of particles to the reticle 200 (especially the reticle pattern on the reticle 200) during feeding, and provides high-quality exposure without lowering the yield.

While the exposure method 1000 installs the pod 300 in the instant embodiment, it is unnecessary to provide the pod 300 or feed the housing unit 100 to the pod 300, as long as the lid is detachable from the body 110 in the housing unit 100.

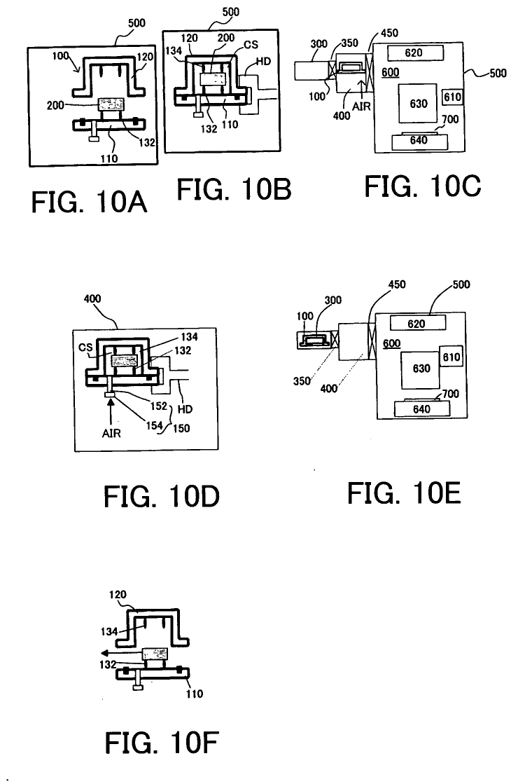

A description will be given of a method for collecting a reticle 200 so as to load another reticle onto the reticle stage 620 after the exposure ends. FIG. 10 is a schematic sectional view for explaining a method for collecting the reticle 200 mounted on the reticle stage 620 in the exposure apparatus 600.

First, as shown in FIG. 10A, the reticle 200 is detached from the reticle stage 620 and set to the first support members 132 provided on the body 110. Next, as shown in FIG. 10B, the lid 120 is attached to the body 110 that loads the reticle 200 so as to accommodate the reticle 200 in the accommodation space CS. In this case, the hand HD adheres the body 110 to the lid 120 in the housing unit 100.

After the reticle 200 is housed in the housing unit 100, the valve 450 is opened between the load lock chamber 400 and the exposure chamber 500 as shown in FIG. 10C, and the housing unit 100 is fed from the exposure chamber 500 to the load lock chamber 400. After the housing unit 100 is fed to the load lock chamber 400, the valve 450 is closed between the load lock chamber 400 and exposure chamber 500, and the clean air is supplied to the load lock chamber 400 from the air supply source (not shown). As soon as the air is supplied to the load lock chamber 400, the valve 154 of the air supply and exhaust opening 152 is opened as shown in FIG. 10D, so as to supply the clean air from the air supply source (not shown) to the accommodation space CS in the housing unit 100. Thereby, the pressure in the accommodation space CS in the housing unit 100 is equal to the air pressure.

Next, as shown in FIG. 10E, the valve 350 is opened between the pod 300 and the load lock chamber 400, and the housing unit 100 is fed from the load lock chamber 400 to the pod 300. Then, the valve 350 between the pod 300 and the load lock chamber 400 is closed, as shown in FIG. 10F, and the lid 120 is detached from the body 110 under the clean environment (not shown) and the housing unit 100 is taken out of the reticle 200.

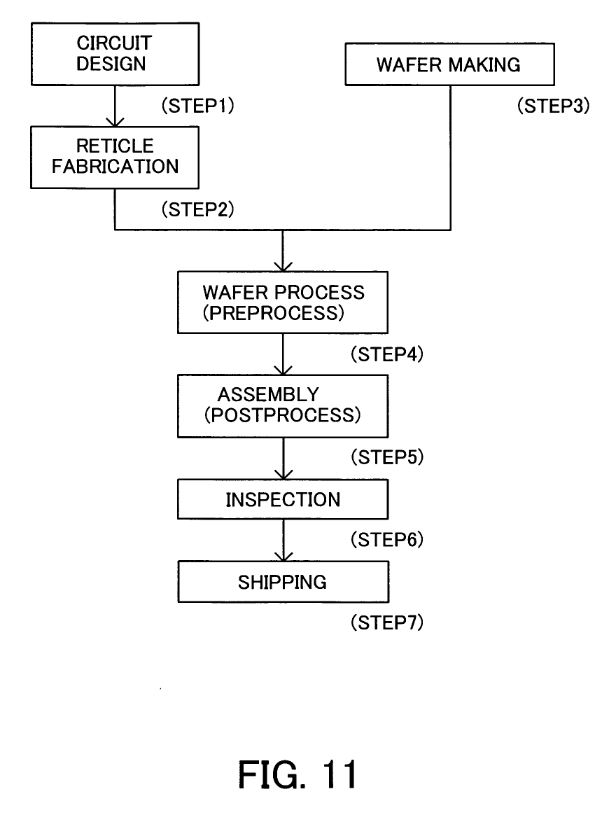

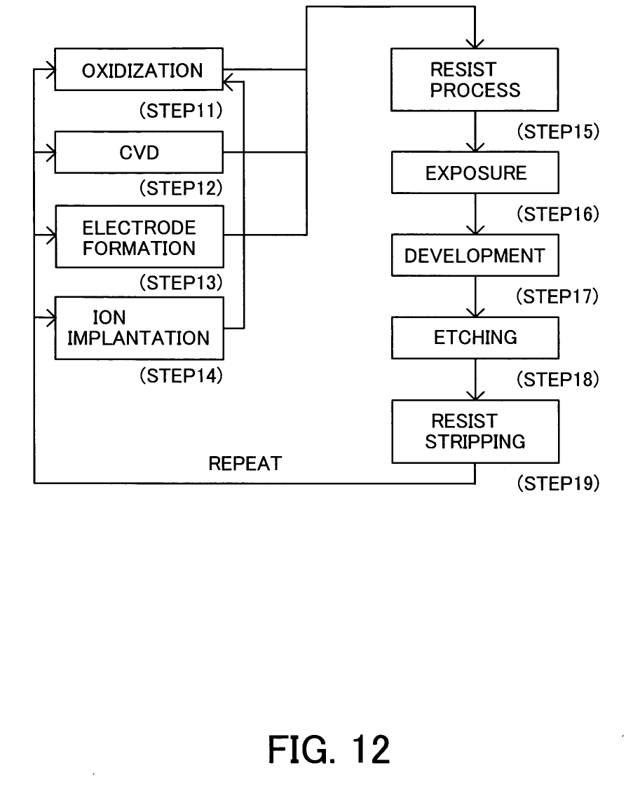

Referring to FIGS. 11 and 12, a description will now be given of an embodiment of device fabrication method using the above exposure method 1000. FIG. 11 is a flowchart for explaining a fabrication of devices (i.e., semiconductor chips such as IC and LSI, LCDs, CCDs). Here, a description will be given of the fabrication of a semiconductor chip as an example. Step 1 (circuit design) designs a semiconductor device circuit. Step 2 (reticle fabrication) forms a reticle having a designed circuit pattern. Step 3 (wafer making) manufactures a wafer using materials such as silicon. Step 4 (wafer process), which is also referred to as a pretreatment, forms actual circuitry on the wafer through photolithography using the reticle and wafer. Step 5 (assembly), which is also referred to as a posttreatment, forms into a semiconductor chip the ware formed in step 4 and includes a assembly step (e.g., dicing, bonding), a packaging step (chip sealing), and the like. Step 6 (inspection) performs various tests for the semiconductor device made in Step 5, such as a validity test and a durability test. Through these steps, a semiconductor device is finished and shipped (Step 7).

FIG. 7 is a detailed flowchart of the wafer process in Step 4. Step 11 (oxidation) oxidizes wafer's surface. Step 12 (CVD) forms an insulating film on the wafer's surface. Step 13 (electrode formation) forms electrodes on the wafer by vapor disposition and the like. Step 14 (ion implantation) implants ions into the wafer. Step 15 (resist process) applies a photosensitive material onto the wafer. Step 16 (exposure) uses the exposure apparatus 1 to expose a circuit pattern on the reticle onto the wafer. Step 17 (development) develops the exposed wafer. Step 18 (etching) etches part other than a developed resist image. Step 19 (resist stripping) removes disused resist after etching. These steps are repeated, and multi-layer circuit patterns are formed on the wafer. The fabrication method of the instant embodiment may manufacture higher quality devices than the prior art. Thus, the device fabrication method using the inventive lithography technology, and the devices as finished goods also constitute one aspect of the present invention.

Further, the present invention is not limited to these preferred embodiments, and various variations and modifications may be made without departing from the spirit and scope of the present invention. For example, the present invention is applicable to an exposure apparatus having an exposure light source, such as an ArF excimer laser, a KrF excimer laser, a F₂ laser, etc.

This application claims foreign priority under 35 U.S.C. §119, based on from Japanese Patent Application No. 2003-354682, filed on Oct. 15, 2003, which is hereby incorporated by reference herein.

1. A housing unit used to feed an object from a first atmosphere to a second atmosphere different from the first atmosphere, said housing unit comprising:
a support member for supporting the object via a contact surface that contacts the object; and
an antislip device that prevents slippery of the object relative to said support member.

2. A housing unit according to claim 1, further comprising a body, and a lid that can be detached from the body, and
wherein each of said body and lid is provided with said support member so as to hold the object to be fed.

3. A housing unit according to claim 1, wherein the antislip device is an elastic member provided at least on the contact surface.

4. A housing unit according to claim 3, wherein the elastic member has a Young's modulus of 1×10⁻² Pa or smaller.

5. A housing unit according to claim 1, wherein said antislip device is provided on the contact surface, and includes a chuck for clamping the object.

6. A housing unit according to claim 5, wherein the chuck is an electrostatic clamping plate that generates an electrostatic absorptive force.

7. A housing unit according to claim 6, wherein the electrostatic absorptive force is 50 N or greater.

8. A housing unit according to claim 1, further comprising a differential pressure remover for removing a pressure difference between the inside and the outside of the housing unit.

9. A housing unit according to claim 1, wherein the object to be fed is a reticle that has a pattern surface, on which a predetermined pattern is formed.

10. A housing unit according to claim 1, wherein the object to be fed is a wafer, onto which a predetermined pattern is formed.

11. A housing unit according to claim 1, further comprising an airtight member that airtightly seals the first atmosphere from the second atmosphere.

12. A housing unit used to feed an object from a first atmosphere to a second atmosphere different from the first atmosphere, said housing unit comprising a support member for supporting the object and follows slips of the object.

13. A housing unit according to claim 12, wherein the object to be fed is a reticle that has a pattern surface, on which a predetermined pattern is formed.

14. A housing unit according to claim 12, wherein the object to be fed is a wafer, onto which a predetermined pattern is formed.

15. A housing unit according to claim 12 further comprising an airtight member that airtightly seals the first atmosphere from the second atmosphere.

16. An exposure method that uses an exposure apparatus that includes an exposure chamber maintained under a reduced pressure or in a vacuum atmosphere, to expose a pattern on a reticle onto a wafer, said exposure method comprising the steps of:
accommodating the reticle in a housing unit according to claim 1;
exhausting the inside of the housing unit that accommodates the reticle by said accommodating step, down to the reduced pressure or vacuum atmosphere;
feeding the housing unit to the exposure chamber inside of which has the reduced pressure or vacuum atmosphere; and
setting in the exposure apparatus the reticle accommodated in the housing unit fed by said feeding step.

17. An exposure method that uses an exposure apparatus that includes an exposure chamber maintained under a reduced pressure or in a vacuum atmosphere, to expose a pattern on a reticle onto a wafer, said exposure method comprising the steps of:
accommodating the wafer in a housing unit according to claim 1;
exhausting the inside of the housing unit that accommodates the wafer by said accommodating step, down to the reduced pressure or vacuum atmosphere;
feeding the housing unit to the exposure chamber inside of which has the reduced pressure or vacuum atmosphere; and
setting in the exposure apparatus the wafer accommodated in the housing unit fed by said feeding step.

18. An exposure method that uses an exposure apparatus that includes an exposure chamber maintained under a reduced pressure or in a vacuum atmosphere, to expose a pattern on a reticle onto a wafer, said exposure method comprising the steps of:
accommodating the reticle in a housing unit according to claim 12;
exhausting the inside of the housing unit that accommodates the reticle by said accommodating step, down to the reduced pressure or vacuum atmosphere;
feeding the housing unit to the exposure chamber inside of which has the reduced pressure or vacuum atmosphere; and
setting in the exposure apparatus the reticle accommodated in the housing unit fed by said feeding step.

19. An exposure method that uses an exposure apparatus that includes an exposure chamber maintained under a reduced pressure or in a vacuum atmosphere, to expose a pattern on a reticle onto a wafer, said exposure method comprising the steps of:
accommodating the wafer in a housing unit according to claim 12;
exhausting the inside of the housing unit that accommodates the wafer by said accommodating step, down to the reduced pressure or vacuum atmosphere;
feeding the housing unit to the exposure chamber inside of which has the reduced pressure or vacuum atmosphere; and
setting in the exposure apparatus the wafer accommodated in the housing unit fed by said feeding step.

20. A device fabricating method comprising the steps of:
exposing a pattern on the reticle onto the wafer by using an exposure method according to claim 16; and
developing the wafer exposed.

21. A device fabricating method comprising the steps of:
exposing a pattern on the reticle onto the wafer by using an exposure method according to claim 17; and
developing the wafer exposed.

22. A device fabricating method comprising the steps of:
exposing a pattern on the reticle onto the wafer by using an exposure method according to claim 18; and
developing the wafer exposed.

23. A device fabricating method comprising the steps of:
exposing a pattern on the reticle onto the wafer by using an exposure method according to claim 19; and
developing the wafer exposed.
